(19) United States
(12) Patent Application Publication
(10) Pub. No.: US 2016/0178110 A1
(43) Pub. Date: Jun. 23, 2016

(54) ANTI-LEAKAGE DEVICE

(71) Applicant: KUO-CHI CHANG, NEW TAIPEI CITY (TW)

(72) Inventor: KUO-CHI CHANG, NEW TAIPEI CITY (TW)

(21) Appl. No.: 14/944,604

(22) Filed: Nov. 18, 2015

(30) Foreign Application Priority Data
Dec. 18, 2014 (TW) 103222424

(51) Int. Cl. F16L 55/16; B65D 39/00

(52) U.S. Cl. CPC F16L 55/1612; B65D 39/0052

(57) ABSTRACT

An anti-leakage device includes an insertion rod and a plug unit. The insertion rod has an insertion segment and an exposed segment opposite to the insertion segment. The plug unit includes frustoconical first and second plug members that are mounted on the insertion segment of the insertion rod and made of an elastic material, and that are respectively distal from and proximate to the exposed segment of the insertion rod. Each of the first and second plug members has a small end surface and a large end surface that are opposite to each other. One of the first and second plug members is adapted to be plugged into a hole of a liquid container with the exposed segment of the insertion rod being adapted to be exposed from the liquid container.

### CROSS-REFERENCE TO RELATED APPLICATION

This application claims priority of Taiwanese Application No. 103222424, filed on Dec. 18, 2014.

### FIELD

The disclosure relates to an anti-leakage device, more particularly to an anti-leakage device adapted to be plugged into a hole in a liquid container for preventing leakage of liquid from the hole.

### BACKGROUND

When a hole or crack is found on a liquid container, a piece of cloth or similar fabric is jammed into the hole or crack to prevent leakage of liquid stored therein. While this may be sufficient as a temporary measure for the sake of expediency, the effectiveness of such means of preventing leakage is often compromised due to liquid pressure within the liquid container, and when the liquid stored therein is chemical or toxic in nature, e.g. chemical fluids, gasoline, a safer and more effective anti-leakage device is called for.

### SUMMARY

Therefore, an object of the disclosure is to provide an anti-leakage device that can alleviate the drawback of the prior art.

According to the disclosure, an anti-leakage device includes an insertion rod and a plug unit.

The insertion rod has an insertion segment and an exposed segment opposite to the insertion segment.

The plug unit includes a first plug member and a second plug member that are mounted on the insertion segment of the insertion rod, that are respectively distal from and proximate to the exposed segment of the insertion rod, that are made of an elastic material, and that are frustoconical. Each of the first and second plug members has a small end surface and a large end surface that are opposite to each other along the insertion segment of the insertion rod, and that are respectively distal from and proximate to the exposed segment of the insertion rod. The large end surface of the second plug member has a diameter larger than that of the large end surface of the first plug member, and one of the first and second plug members is adapted to be plugged into a hole of a liquid container with the exposed segment of the insertion rod being adapted to be exposed from the liquid container.

### BRIEF DESCRIPTION OF THE DRAWINGS

Other features and advantages of the disclosure will become apparent in the following detailed description of the embodiments with reference to the accompanying drawings, of which:

FIG. 1 is a sectional view illustrating the embodiment of an anti-leakage device according to the disclosure;

FIG. 2 is partly sectional view of the embodiment of the anti-leakage device of FIG. 1 in a state of use and provided with a handle;

FIG. 3 is a partly sectional view of the embodiment of the anti-leakage device of FIG. 1 in a state of use and provided with a bolt;

FIG. 4 is a top view of the embodiment of the anti-leakage device of FIG. 3 in a state of use and provided with a fastening belt being looped around and fixed to the bolt and a liquid container; and

FIG. 5 is a partly sectional view showing another configuration of the embodiment of the anti-leakage device of FIG. 2 in use.

### DETAILED DESCRIPTION

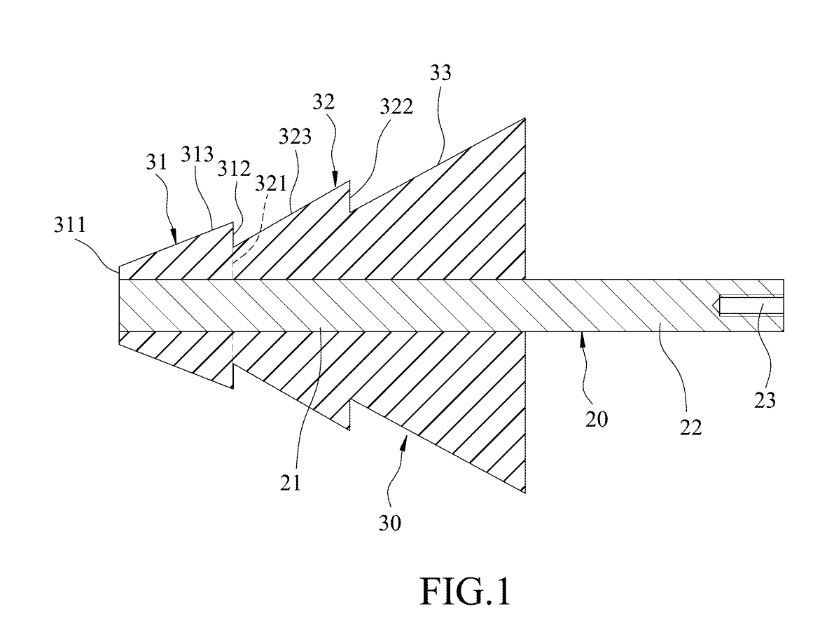

Referring to FIGS. 1, 2 and 3, the embodiment of an anti-leakage device according to the disclosure, which is adapted to be plugged into a hole 11 in a liquid container 10 for preventing leakage of liquid 12 from the hole, includes an insertion rod 20 and a plug unit 30.

The insertion rod 20 has an insertion segment 21, an exposed segment 22 opposite to the insertion segment 21, and a threaded hole 23 formed in the exposed segment 22 and lengthwisely extending along the insertion rod 20.

The plug unit 30 has a first plug member 31 and a second plug member 32 that are mounted on the insertion segment 21 of the insertion rod 20, that are respectively distal from and proximate to the exposed segment 22 of the insertion rod 20, and that are frustoconical in shape. One of the first and second plug members 31, 32 is adapted to be plugged into the hole 11 of the liquid container 10 with the exposed segment 22 being adapted to be exposed from the liquid container 10.

Each of the first and second plug members 31, 32 has a small end surface 311, 321 and a large end surface 312, 322 that are opposite to each other along the insertion segment 21 and that are respectively distal from and proximate to the exposed segment 22, and a connecting surface 313, 323. The large end surface 322 of the second plug member 32 has a diameter larger than that of the large end surface 312 of the first plug member 31. In this embodiment, the large end surface 312 of the first plug member 31 and the small end surface 321 of the second plug member 32 overlap each other. The plug unit 30 may be made of rubber so that the plug unit 30 recovers resiliently after deformation.

It is worth mentioning that a third plug member 33, or even a fourth or fifth plug member (not shown), may be included in the embodiment, with the first plug member 31 being the smallest in size, the rest gradually increasing in size, and the plug member closest to the exposed segment 22 being the largest in size.

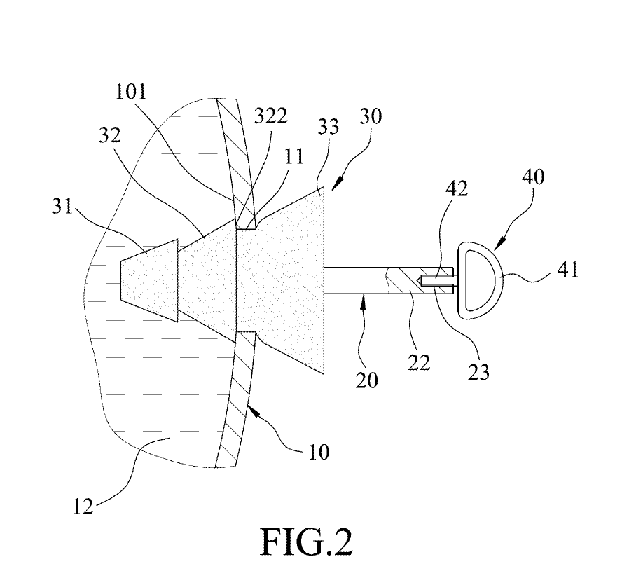

As shown in FIG. 2, the anti-leakage device may further include a handle 40 that is threadedly and removably secured to the exposed segment 22 of the insertion rod 20, and has a grip portion 41 and a threaded rod 42 that is fixedly connected to the grip portion 41 and that threadedly engages the threaded hole 23 of the insertion rod 20 for locking the handle 40 to the insertion rod 20.

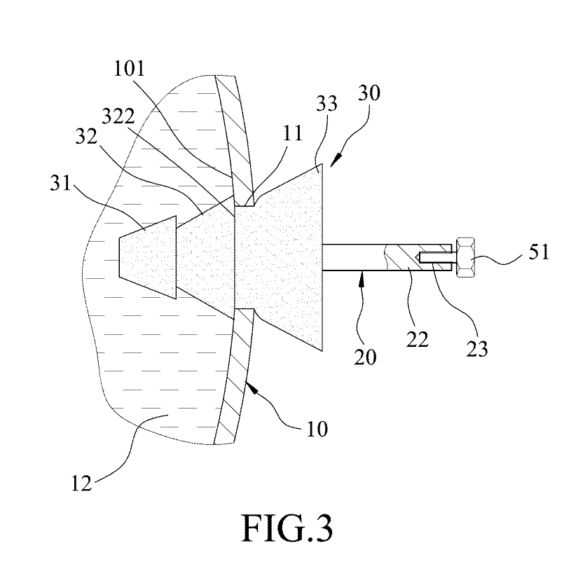

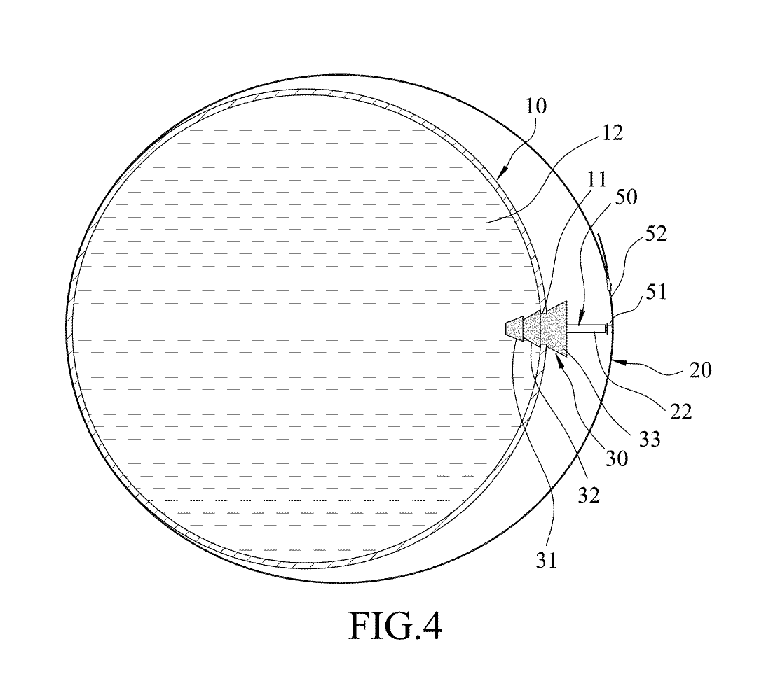

As shown in FIGS. 3 and 4, the anti-leakage device may further include a fastening unit 50. The fastening unit 50 has a bolt 51 that is threadedly and removably secured to the exposed segment 22 of the insertion rod 20, and a fastening belt 52 that is adapted to surround the bolt 51 and the liquid container 10 for fixing the anti-leakage device of the disclosure on the liquid container 10.

Referring back to FIG. 2, when in use, where a user, upon discovering a hole 11 in the liquid container 10, may grasp the anti-leakage device of the disclosure by the handle 40 and quickly plug the plug unit 30 into the hole 11. When the hole 11 is larger in diameter than the large end surface 312 of the first plug member 31, the plug unit 30 may be extended further into the liquid container 10 until the first plug member 31 passes entirely into the liquid container 10 and the small end surface 321 of the second plug member 32 enters the liquid container 10. Should the second plug member 32 be met with resistance, which signifies that the large end surface 322 of the second plug member 32 is larger in diameter than the hole 11, the user may apply more pressure against the plug unit 30 so that the second plug member 32 deforms to allow the large end surface 322 thereof through the hole, at which time the second plug member 32 recovers resiliently such that the large end surface 322 abuts against an inner surface 101 of the liquid container 10 and covers the hole 11 from inside the liquid container 10, with only a short outward tug on the handle 40 required from the user. In this way, any further leakage from the liquid container 10 may be prevented. In practice, however, the final tug on the embodiment may be omitted due to liquid pressure applied on the immersed plug unit 30 from the liquid 12 within the liquid container 10, which forces the large end surface 322 against the inner surface 101.

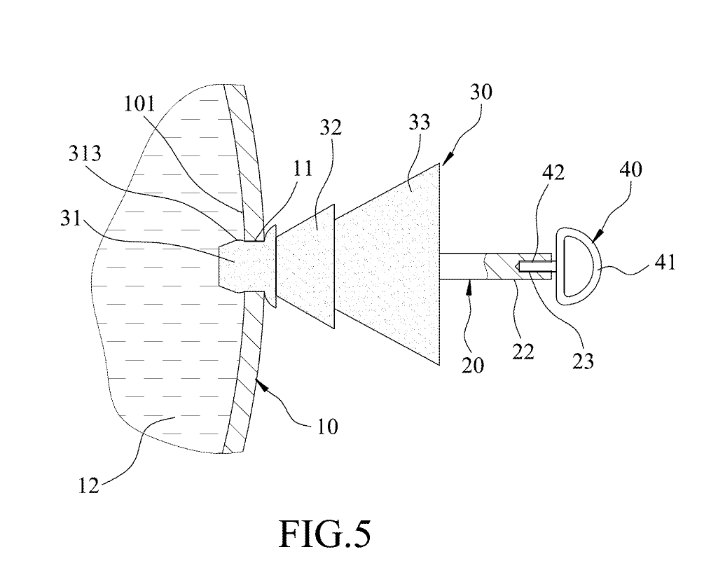

Referring to FIG. 5, should the hole 11 be too small for the large end surface 311 of the first plug member 31 to pass through, the user may also plug the hole 11 with the connecting surface 313 of the first plug member 31 being jammed against the periphery of the hole 11 to achieve the same anti-leakage effect.

Further referring to FIGS. 3 and 4, when in use, an even better anti-leakage effect may be achieved by the embodiment by threadedly removing the handle 40 (see FIG. 2) and threadedly engaging in its stead the bolt 51 with the insertion rod 20, so that the fastening belt 52 may be looped around and fastened to the bolt 51 and the liquid container 10 for stabilizing the plug unit 30 against any outward pushing force from the liquid pressure of the liquid 12 within the liquid container 10.

It should be noted that the anti-leakage device of the present disclosure may also be used on liquid conveying pipes or tubes (not shown) to achieve the same anti-leakage effect.

According to the disclosure, the anti-leakage device has at least the following advantages:

1. The plug unit 30 of the embodiment has more than one plug members 31, 32, 33 that are different in size and that become larger as they near the exposed segment 22 of the insertion rod 20. With this design, the user may plug the hole 11 with one of the plug members 31, 32, 33 that is larger in size than the hole 11 in the manner described above, thereby effectively stopping the leakage and potentially relieving an otherwise emergency situation.

2. The fastening unit 50 of the embodiment firmly fixes the anti-leakage device to the liquid container 10, thereby preventing the liquid pressure of the liquid 12 from loosening the plug unit 30 and ensuring optimal anti-leakage effect.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An anti-leakage device adapted to be plugged into a hole in a liquid container for preventing leakage of liquid from the hole, said anti-leakage device comprising:
an insertion rod that has an insertion segment, and an exposed segment opposite to said insertion segment; and
a plug unit that includes a first plug member and a second plug member that are mounted on said insertion segment of said insertion rod, that are respectively distal from and proximate to said exposed segment of said insertion rod, that are made of an elastic material, and that are frustoconical, each of said first and second plug members having a small end surface and a large end surface that are opposite to each other along said insertion segment of said insertion rod, and that are respectively distal from and proximate to said exposed segment of said insertion rod, said large end surface of said second plug member having a diameter larger than that of said large end surface of said first plug member, one of said first and second plug members being adapted to be plugged into the hole of the liquid container with said exposed segment of said insertion rod being adapted to be exposed from the liquid container.

2. The anti-leakage device as claimed in claim 1, wherein said anti-leakage device further comprises a handle threadedly and removably secured to said exposed segment of said insertion rod.

3. The anti-leakage device as claimed in claim 1, further comprising a fastening unit including a bolt that is threadedly and removably secured to said exposed segment of said insertion rod, and a fastening belt that is adapted to surround said bolt and the liquid container for fixing said anti-leakage device on the liquid container.
